(19) United States
(12) Patent Application Publication
(10) Pub. No.: US 2008/0028674 A1
(43) Pub. Date: Feb. 7, 2008

(54) Method of Operating Internal Combustion Engine by Introducing Antioxidant into Combustion Chamber

(75) Inventors: Mitchell M. Jackson, Chagrin Falls, OH (US); David C. Arters, Solon, OH (US); Malcolm G. J. Macduff, Quarndon (GB); Derek W. Mackney, Duffield (GB)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation, Wickliffe, OH (US)

(21) Appl. No.: 11/869,944

(22) Filed: Oct. 10, 2007

Related U.S. Application Data
(63) Continuation of application No. 10/511,003, filed on Oct. 12, 2004.
(60) Provisional application No. 60/374,640, filed on Apr. 23, 2002.

(51) Int. Cl. C10L 1/18; F02B 51/00

(52) U.S. Cl. 44/450; 123/575

(57) ABSTRACT

In a method of operating an internal combustion engine, an antioxidant composition is introduced into a combustion chamber of the engine. The antioxidant composition contains (A) a sterically hindered phenol; (B) an alkylene or alkylidene coupled sterically hindered phenol oligomer; (C) a secondary aromatic amine; (D) a reaction product of a hydrocarbyl-substituted hydroxy-containing aromatic compound, an aldehyde, and a carboxyl-substituted phenol; or (E) a mixture thereof. The method improves the performance of a lubricating oil of the engine.

This application claims the benefit of U.S. Provisional Application No. 60/374,640 filed 23 Apr. 2002.

### FIELD OF THE INVENTION

This invention comprises a method of operating an internal combustion engine that comprises introducing an antioxidant composition into a combustion chamber of the engine during the operation of the engine. The method improves the performance of a lubricating oil of the engine.

### BACKGROUND OF THE INVENTION

A complication facing modern compression-ignited and spark-ignited engines is the build tip of soot or sludge in the lubricating oil due to oxidation and nitration by-products of the unburnt fuel or the lubricating oil itself. The buildup of this soot and sludge causes thickening of the lubricating oil and can cause engine deposits. In severe operating conditions, the oil can thicken to the point of gelling. When the soot or sludge levels get high, a corresponding increase in the viscosity of the lubricating oil can result in poor lubrication at critical wear points on the engine. This poor lubrication results in high wear results, higher amounts of piston deposits are formed, a loss in fuel economy occurs, and increased emissions such as particulates are observed. The net result is a shorter effective life of the lubricating oil.

Another complication facing engine lubricants for modern and future engines is the need for these engines to have exhaust treatment systems in order to meet upcoming emission legislation. In order to maintain the performance of these exhaust treatment devices, the content of key elements used in lubricant formulations will be reduced such as sulfur, phosphorus and sulfated ash which is a measure of metal content. These elements can occupy active sites on the exhaust treatment devices and reduce their efficiency over time. Reducing the sulfur, phosphorous and sulfated ash in the lubricant is being done to increase the efficiency and the life of exhaust treatment devices such as catalytic converters, oxidation catalysts, diesel particulate filters and NOx traps. Additional demands on the performance of lubricating oils are extended drain intervals for the lubricating oil which requires a longer oil life and exhaust gas recirculation (EGR) systems that reduce NOx generation, increase soot levels in the oil, and require viscosity control from the oil.

A source of the sulfur and phosphorus found in lubricating oils originates from antiwear, antioxidant and some metallic detergent additives and may also arise from the base oils utilized. One additive in particular is the antiwear and antioxidant additive zinc dialkyl dithio phosphate (ZnDTP). In lubricating oils, antioxidants such as ZnDTP function to control undesirable chemical reactions that result in the formation of soot, sludge, carbon, and varnish produced primarily by the incomplete combustion of the fuel, or impurities in the fuel, or impurities in the base oil used in the lubricating oil composition. Although non-phosphorus replacements for ZnDTP exist, a majority of them are still based upon sulfur, their costs are considerably higher, and some have potential negative side effects.

Specified levels of sulfur, phosphorous and sulfated ash such as the future ILSAC GF-4 specifications are projected to be significantly lower for future lubricating oils. In the absence of critical antioxidants, such as ZnDTP, low phosphorous low sulfur engine oils will be more susceptible to sludge formation due to the incomplete combustion and oxidation of fuel and oil components. As with soot in diesel engines, increased levels of sludge in gasoline engines also leads to excessive wear, increased engine deposits, loss in fuel economy, and increased emissions. Thus, these specifications are conflicting with the need to increase additive levels, such as ZnDTP, to maintain performance throughout engine drain intervals.

U.S. Provisional Application No. 60/368,354 filed 28 Mar. 2002 discloses a process for using a low ash detergent/dispersant in a fuel to enhance performance and life of a lubricating oil in the operation of an internal combustion engine.

This invention provides a way to provide enhanced performance and life of a lubricating oil while minimizing the complications involved with formulating lubricating oils.

### SUMMARY OF THE INVENTION

It is an object of this invention to enhance the performance and life of lubricating oil used in an internal combustion engine.

Another object of this invention is to enhance the performance and life of a low phosphorous/low sulfur/low sulfate ash lubricating oil used in an internal combustion engine.

A further object of this invention is to enhance the performance and life of a lubricating oil used in an internal combustion engine equipped with an exhaust gas recirculation system.

A still further object of this invention is to enhance the performance and life of a low phosphorous/low sulfur/low sulfate ash lubricating oil of an internal combustion engine equipped with an exhaust treatment device.

An additional object of the invention is to enhance the performance and life of a lubricating oil of an internal combustion engine equipped with an exhaust treatment device where a fuel of a fuel composition used to fuel the engine is a low sulfur content fuel.

Additional objects and advantages of the present invention will be set forth in the Detailed Description which follows and, in part, will be obvious from the Detailed Description or may be learned by the practice of the invention. The objects and advantages of the invention may be realized by means of the instrumentalities and combinations pointed out in the appended claims.

To achieve the foregoing objects in accordance with the invention as described and claimed herein, a method of operating an internal combustion engine comprises introducing an antioxidant composition comprising (A) a sterically hindered phenol; (B) an alkylene or alkylidene coupled sterically hindered phenol oligomer; (C) a secondary aromatic amine; (D) a reaction product of a hydrocarbyl-substituted hydroxy-containing aromatic compound, an aldehyde, and a carboxyl-substituted phenol, or (FE) a mixture thereof into a combustion chamber of the engine during the operation of the engine.

In another embodiment of the present invention the method of operating an internal combustion engine improves the performance of a lubricating oil of the engine.

In a further embodiment of the invention the method of operating an internal combustion engine improves the performance of a lubricating oil of the engine where the engine has an exhaust gas recirculation system.

In yet another embodiment of this invention the method of operating an internal combustion engine improves the performance of a lubricating oil of the engine where the engine has an exhaust treatment device and the lubricating oil has a reduced level of phosphorus and/or sulfur and/or sulfated ash.

In still a further embodiment of the invention the method of operating an internal combustion engine improves the performance of a lubricating oil of the engine where the engine has a recommended drain interval for the lubricating oil of the engine that is extended from a normal drain interval to greater than 6,000 miles or 150 operational hours.

In an additional embodiment of the invention the method of operating an internal combustion engine improves the performance of a lubricating oil of the engine where the engine has an exhaust treatment device and a fuel of a fuel composition used to fuel the engine has a sulfur content below 80 ppm by weight.

### DETAILED DESCRIPTION OF THE INVENTION

A method of the present invention of operating an internal combustion engine comprises introducing an antioxidant composition comprising (A) a sterically hindered phenol; (B) an alkylene or alkylidene coupled sterically hindered phenol oligomer; (C) a secondary aromatic amine; (D) a reaction product of a hydrocarbyl-substituted hydroxy-containing aromatic compound, an aldehyde, and a carboxyl-substituted phenol; or (E) a mixture thereof into a combustion chamber of the engine during the operation of the engine.

Throughout this application the term hydrocarbyl represents a univalent group of one or more carbon atoms that is predominately hydrocarbon in nature, but can contain heteroatoms such as oxygen in the carbon chain and can have nonhydro-carbon and heteroatom-containing groups such as hydroxy, halo, nitro and alkoxy attached to the carbon chain.

In the method of this invention of operating an internal combustion engine, the internal combustion engine can include various spark-ignited and compression-ignited engines. In one embodiment of the invention the engine contains an exhaust gas recirculation (FEGR) system for recirculating at least part of its exhaust gas into the intake air supply of the engine, in another embodiment the engine has an exhaust treatment device and a lubricating oil with reduced levels of phosphorus and/or sulfur and/or sulfated ash, in a further embodiment the engine has a recommended drain interval for the lubricating oil of the engine that is extended from a normal drain interval to greater than 6,000 miles or 150 operational hours, and in still a further embodiment the engine has an exhaust treatment device and a fuel of a fuel composition used to fuel the engine has a sulfur content below 80 ppm by weight. The internal combustion engine of the invention can include automobile and truck engines, two-cycle engines, aviation piston engines, marine and railroad diesel engines, and the like. Also included are engines for off road vehicles and equipment. The compression-ignited or diesel engines include those for both mobile and stationary power plants. The diesel engines include those used in urban buses as well as all classes of trucks. The diesel engines may be of the two-stroke per cycle or four-stroke per cycle type. The diesel engines include heavy duty diesel engines.

The antioxidant composition of the present invention can include (A) a sterically hindered phenol. The sterically hindered phenol can contain an alkyl group ortho to the hydroxyl group, two alkyl groups ortho to the hydroxyl group that occupy the 2-position and 6-position of the phenolic ring, or a mixture thereof. The alkyl groups can contain 1 to 24 carbon atoms and in other instances 3 to 18 and 3 to 12 carbon atoms. The alkyl groups can be linear, branched to include tertiary alkyl groups, or a mixture thereof. The sterically hindered phenol can also contain one or more additional alkyl groups and/or one or more hydrocarbyl groups such as a propionate ester group. Useful sterically hindered phenols can include ortho-alkylated phenolic compounds such as for example 2,6-ditertbutylphenol, 4-methyl-2,6-di-tertbutylphenol, 2,4,6-tritertbutylphenol, 2-tert-butylphenol, 2,6-diisopropylphenol, 2-methyl-6-tert-butylphenol, 2,4-dimethyl-6-tert-butylphenol, 4-(N,N-dimethylaminomethyl)-2,6-di-tertbutyl phenol, 4-ethyl-2,6-di-tertbutylphenol, and their analogs and homologs. Mixtures of two or more such mononuclear phenol compounds are also suitable.

In an embodiment of the invention the sterically hindered phenol can be 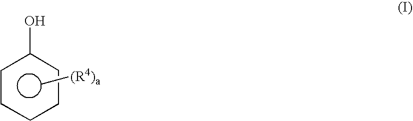
represented by the formula (I) wherein R⁴ is an alkyl group containing 1 up to 24 carbon atoms and a is an integer of 1 to 5. Preferably R⁴ contains 4 to 18 carbon atoms and most preferably from 4 to 12 carbon atoms. R⁴ may be either straight chained or branched chained; branched chained is generally preferred. The value for a can be 1 to 4, 1 to 3, or 2. Preferably the phenol is a butyl substituted phenol containing 2 or 3 t-butyl groups. When a is 2 and t-butyl groups occupy the 2- and 6-positions of phenol, the phenol is extremely sterically hindered: 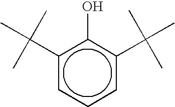
In an embodiment of the invention the sterically hindered phenol can be 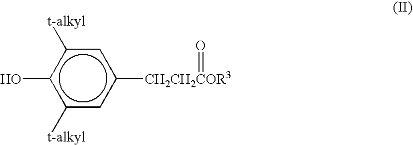
represented by formula (II) wherein the t-alkyl groups can have 4 to 8 carbon atoms, and R³ is a straight chain or branched chain alkyl group containing 2 to 22 carbon atoms, preferably 2 to 8, more preferably 2 to 6 carbon atoms and more preferably 4. R³ is desirably a 2-ethylhexyl group or an n-butyl group. Hindered, ester-substituted phenols such as those of formula (II) can be prepared by heating a 2,6-dialkylphenol with an acrylate ester under base catalysis conditions such as aqueous KOH as described in International Publication No. WO01/74978. In another embodiment of this invention the sterically hindered phenol is an alkylation reaction product of an alkylphenol such as a dodecylphenol and isobutylene to form a product containing a di-t-butylated alkylphenol. An embodiment of the invention is a sterically hindered phenol having two or more alkyl substituents that contain 1 to 24 carbon atoms and that occupy the 2-position and 6-position of the phenolic ring.

The antioxidant composition of this invention can include (B) an alkylene or alkylidene coupled sterically hindered phenol oligomer. The coupled sterically hindered phenol oligomer can contain two or more phenolic rings where each ring is occupied at the 2-, 4- and 6-positions by an alkyl group such as a methyl or t-butyl group or an arylalkyl group such as a 3,5-di-t-butyl-4-hydroxybenzyl group. The alkylene and alkylidene coupling groups can be respectively methylene and ethylidene groups. The alkyl groups can have 1 to 24 carbon atoms and in other instances can have 3 to 18 and 3 to 12 carbon atoms. The alkyl groups can be linear, branched to include tertiary alkyl groups, or a mixture thereof. The coupled sterically hindered phenol oligomer can include a mixture of two or more oligomers where each oligomer contains a different number of phenolic rings. The coupling of the phenolic rings in an oligomer can be at ortho ring positions, at para ring positions, or at a mixture of ortho and para ring positions.

In an embodiment of the invention the antioxidant composition (B) is a coupled alkylphenol which can be represented by the formula (III) 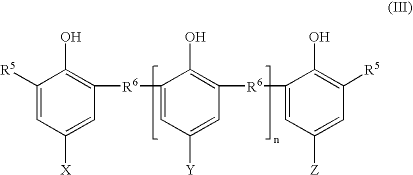
wherein each R⁵ is independently a tertiary alkyl group containing from 4 to about 8 carbon atoms, each of X, Y and Z is independently hydrogen or a hydrocarbon radical, each R⁶ is independently an alkylene or alkylidene group, and n is a number ranging from zero to about 4. Each R⁵ group must be a tertiary alkyl group. Tertiary alkyl groups have the general structure 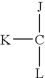
wherein each of J, K and L is an alkyl group of 1-4 carbon atoms. Representative tertiary alkyl groups are tertiary butyl, tertiary amyl, tertiary hexyl and tertiary octyl. The R⁵ groups may be the same or different. Preferably all R⁵ are the same, more preferably, they are all tertiary butyl groups. Each R⁶ is independently a divalent group such as an alkylene or an alkylidene group. These groups may be substituted for example by various hydrocarbyl groups such as alkyl and aryl groups. Representative examples of suitable R⁶ groups are methylene, ethylene, propylene, phenyl substituted methylene, methyl substituted methylene, methyl substituted ethylene and the like. Typically, each R⁶ contains from one to about 10 carbon atoms, preferably from one to about three carbon atoms. In one preferred embodiment, R⁶ is phenyl substituted methylene. In a most preferred embodiment, each is methylene, that is a group of the formula —CH₂. Each X, Y and Z is independently hydrogen or a hydrocarbon-based group. These groups may be the same or different. In a particularly preferred embodiment, each of X, Y and Z is independently an aliphatic hydrocarbon group. Thus each of these groups will contain at least one carbon atom, but may contain more. Preferably they contain from one to about 500 carbon atoms, preferably from 4 to about 100 carbon atoms, often from about 4 to about 30 carbon atoms.

In an embodiment of the invention the antioxidant composition (B) is a methylene coupled oligomer of a sterically hindered phenol such as for example 4, 4′-methylenebis(6-tert-butyl-2-methylphenol), 4,4′-methylenebis(2-tert-amyl-6-methylphenol), 2,2′-methylenebis(4-methyl-6-tert-butylphenol), 4,4′methylene-bis(2,6-di-tert-butylphenol), and similar compounds. In an embodiment of this invention a methylene coupled oligomer of a stericaily hindered phenol is 2,2′-methylenebis(6-tert-butyl-4-dodecylphenol) as described in U.S. Pat. No. 6,002,051 regarding its preparation and use.

The antioxidant composition of the present invention can include (C) a secondary aromatic amine, typically a monoamine, that contains one aryl group, two aryl groups, or a mixture thereof. An embodiment of the invention is a secondary aromatic amine containing one aryl group such as for example N-methylaniline. The secondary aromatic amine containing one aryl group can also have C₁-C₁₆ alkyl or arylalkyl substituents on the aryl group. In another embodiment of the invention the secondary aromatic amine can be a diarylamine such as for example diphenylamine, N-phenyl-1-naphthylamine and N-phenyl-2-naphthylaminie. The diarylamine can contain one, two or more alkyl and/or arylalkyl substituents. The alkyl and arylalkyl substituents can have 1 to 16 carbon atoms and in other instances can have 3 to 14 and 4 to 12 carbon atoms. The alkyl and arylalkyl substituents can be linear, branched, or a mixture thereof. In an embodiment of the present invention the diarylamine is an alkylated diphenylamine which can be represented by formula (IV)
R⁷—C₆H₄—NH—C₆H₄—R⁸ (IV)
wherein R⁷ and R⁵ are independently a hydrogen or an alkyl group containing 1 to 24 carbon atoms. The diphenylamine of formula (IV) can be a mixture of diphenylamine and monoalkylated and dialkylated diphenylamine. R⁷ and/or R⁸ can be alkyl groups containing from 4 to 20 carbon atoms. In another embodiment of the invention the diphenylamine of formula (IV) is prepared by alkylating diphenylamine with nonenes using well known alkylation methods. Alkylated diarylamines are also commercially available.

The antioxidant composition of the present invention can include (D) a reaction product of a hydrocarbyl-substituted hydroxy-containing aromatic compound, an aldehyde, and a carboxyl-substituted phenol. The hydrocarbyl substituent can be derived from an olefin or a polyolefin, typically a polyolefin. The polyolefin can have 4 to 200 carbon atoms and in other instances 6 to 160 and 8 to 100 carbon atoms. The polyolefin can be a homopolymer from a single monomer such as a polypropylene or a copolymer from two or more monomers such as an ethylene-propylene copolymer. The monomers can be C₂ to C₁₂ olefins such as ethylene, propylene and butenes including isobtutylene. The hydroxy-containing aromatic compound includes phenol and polyhydroxy-containing benzenes such as catechol. The hydrocarbyl-substituted hydroxyaromatic compound can be prepared for example by alkylating phenol with a polyolefin such as a polypropylene or a polyisobutylene or a mixture of two or more polyolefins. The hydrocarbyl-substituted hydroxyaromatic compound can also be prepared for example by separately alkylating the hydroxyaromatic compound with each of two or more polyolefins and then mixing the alkylation products. The aldehyde for antioxidant composition (D) can be a C₁ to C₁₀ aldehyde and includes formaldehyde and acetaldehyde. The carboxyl-substituted phenol can contain hydrocarbyl substituents and includes salicylic acid. The reaction product of the antioxidant composition (D) can be linear, cyclic, or a mixture thereof. The reaction product of antioxidant composition (D) can be an oligomer containing at least one unit of the hydroxy-containing aromatic compound and at least one unit of the carboxyl-substituted phenol. The mole ratio of the hydroxyaromatic compound to the carboxyl-substituted phenol can range from 1:0.1 to 1:2. In an embodiment of the invention the antioxidant composition (D) is the reaction product of an alkylphenol, formaldehyde, and salicylic acid. The reaction product of the antioxidant composition (D) can be prepared for example by reacting a polypropylene or polyisobutylene alkylated phenol, formaldehyde and salicylic acid in the presence of a base such as potassium hydroxide optionally in the presence of a hydrocarbon solvent and/or mineral oil diluent as described in U.S. Pat. No. 6,200,936.

In an embodiment of the invention the antioxidant composition (D) is linear comprising r units of formula (V) 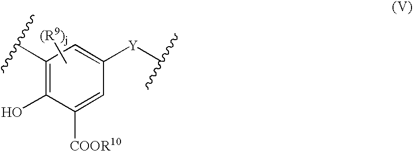
and s units of the formula (VI) 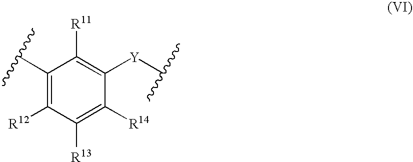
joined together, each end of the compound having a terminal group which is independently one of the following 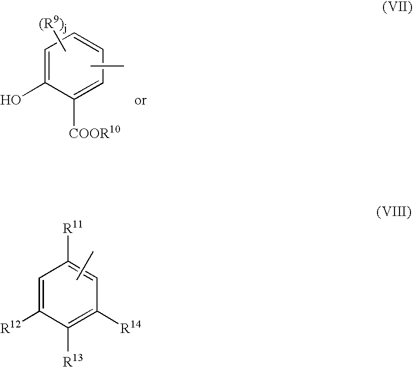
wherein in formulae (V)-(VIII), Y is a divalent bridging group which may be the same or different in each unit; R¹⁰ is hydrogen or a hydrocarbyl group, R⁹ is hydrogen or a hydrocarbyl, j is 1 or 2; R¹³ is hydrogen, a hydrocarbyl or a hetero-substituted hydrocarbyl group; either R¹¹ is hydroxyl and R¹⁴ and R-2 are independently either hydrogen, hydrocarbyl or hetero-substituted hydrocarbyl, or R¹⁴ and R¹² are hydroxyl and R¹¹ is either hydrogen, hydrocarbyl or hetero-substituted hydrocarbyl; r is at least 1; s is at least 2; the ratio of r to s ranges from about 0.1:1 to about 2:1, the total of r+s is at least 3; the linear compound containing at least one block unit containing at least two units corresponding to formula (VI) attached to each other, the linear compound being formed in a reaction mixture optionally containing an organic solvent, the concentration of the organic solvent in the reaction mixture being up to about 48% by weight of the reaction mixture. This invention also relates to metal salts of the foregoing compound, especially overbased metal salts.

In another embodiment of the invention the antioxidant composition (D) is cyclic comprising r units of formula (V) and s units of formula (VI) joined together to form a ring, wherein each Y is a divalent bridging group which may be the same or different in each unit; R¹⁰ is H or an alkyl group of 1 to 6 carbon atoms; R⁹ is H or an alkyl group of 1 to 60 carbon atoms; and j is 1 or 2; R¹³ is hydrogen, a hydrocarbyl or a hetero-substituted hydrocarbyl group; either R¹¹ is hydroxy and R¹⁴ and R¹² are independently either hydrogen, hydrocarbyl or hetero-substituted hydrocarbyl, or R¹⁴ and R¹² are hydroxyl and R¹¹ is either hydrogen, hydrocarbyl or hetero-substituted hydrocarbyl; r is from 1 to 8; s is at least 3, and r+s is 4 to 20. This invention also relates to metal salts of the foregoing compound, especially overbased metal salts.

The antioxidant composition of the present invention can conspires a single component taken from compositions (A) through (D) or can comprise a mixture (E) of two or more components taken from compositions (A) through (D). The mixture (E) can be two or more components taken from a single antioxidant type, for example two components such as di-t-butylated para-cresol and 2,6-di-t-butylphenol taken from (A) sterically hindered phenols. The mixture (E) can be two or more components taken from two or more antioxidant types, for example, two components such as di-t-butylated para-cresol and diphelylamine alkylated with nonenes taken from respectively (A) sterically hindered phenols and (C) secondary aromatic amines.

In an embodiment of the invention the antioxidant composition is essentially free of sulfur and phosphorus indicating that the antioxidant composition does not normally contain sulfur or phosphorus, but that sulfur and phosphorus can be present in trace to minor amounts due to their presence in solvents/diluents and active components.

The method of the present invention of operating an internal combustion engine involves introducing an antioxidant composition into a combustion chamber of the engine. In one embodiment the antioxidant composition is introduced into the combustion chamber by injection from a dosing system. The injection from the dosing system can be directly into the combustion chamber or into a fuel system of the engine such as a fuel storage tank of the fuel system so that the antioxidant composition enters the combustion chamber as a component of a fuel composition. In other embodiments of the invention the antioxidant composition is introduced into the combustion chamber as a component of the fuel composition where the antioxidant composition is added to a fuel in a bulk treatment at a refinery or storage facility or is added to a fuel in an aftermarket treatment such as adding the antioxidant composition to a fuel in a fuel tank of a motor vehicle. When the antioxidant composition is a component of a fuel composition, the antioxidant composition can be present in the fuel composition at 0.1 to 40,000 ppm by weight and in other instances can be present at 1 to 30,000 and 10 to 20,000 and 100 to 1,000 ppm by weight. When the antioxidant composition is introduced into a combustion chamber of an engine directly from a dosing system, it can be introduced at a rate that is equivalent to the levels indicated above for introduction of the antioxidant composition as a component of a fuel composition.

In the method of the present invention an antioxidant composition can be introduced into a combustion chamber of an internal combustion engine as a component of a fuel composition. The fuel composition comprises a normally liquid fuel. The normally liquid fuel can include a hydrocarbon fuel, a nonhydrocarbon fuel, or a mixture thereof. The hydrocarbon fuel can be a petroleum distillate to include a gasoline as defined by ASTM specification D4814 or a diesel fuel as defined by ASTM specification D975. The nonhydrocarbon fuel can be an oxygen-containing composition to include an alcohol, an ether, a nitroalkane, an ester of a vegetable oil, or a mixture thereof. Useful nonhydrocarbon fuels include methanol, ethanol, diethyl ether, methyl t-butyl ether, nitromethane, and methyl esters of vegetable oils such as the methyl ester of rapeseed oil. Useful mixtures of a hydrocarbon and nonhydrocarbon fuel include a mixture of gasoline and ethanol and a mixture of a diesel fuel and a biodiesel fuel such as the methyl ester of rapeseed oil. In an embodiment of the invention the fuel composition comprises an emulsified water in oil composition that contains the normally liquid fuel as described above which can be a hydrocarbon fuel, a nonhydrocarbon fuel, or a mixture thereof. This emulsified water in oil composition can be prepared by a mechanical mixing, by including one or more emulsifiers and/or surfactants in the composition, or by a combination of mechanical mixing and inclusion of emulsifiers and/or surfactants.

The fuel composition of the present invention can further comprise one or more fuel additives to include nitrogen-containing detergents, polyetheramines, metal-containing detergents, antioxidants, rust inhibitors such as alkenylsuccinic acids, corrosion inhibitors, combustion improvers such as nitroalkanes, demulsifiers, antifoaming agents, valve seat recession additives, metal deactivators, lubricity agents, bacteriostatic agents, gum inhibitors, anti-icing agents, anti-static agents, organometallic fuel-borne catalysts for improved combustion performance, low temperature flow improvers, and fluidizers such as mineral oils, polyolefins and polyethers. The fuel composition of the invention can also contain the above described antioxidant composition comprising compositions (A), (B), (C), (D), or (E). The nitrogen-containing detergents can include Mannich reaction products such as for example a hydrocarbyl-substituted phenol reacted with an aldehyde and an amine containing a reactive nitrogen to hydrogen or N—H bond as described in U.S. Pat. No. 5,697,988; a reaction product of a hydrocarbyl-substituted acylating agent and an amine such as for example the reaction product of a polyisobutenylsuccinic anhydride and a polyethylenepolyamine as described in U.S. Pat. No. 4,234,435; a hydrocarbyl-substituted amine such as for example a reaction product of a chlorinated polyisobutylene and a polyamine as described in U.S. Pat. No. 5,407,453; and mixtures thereof. The polyetheramines can include polyetheramines prepared by reacting a hydroxy-containing hydrocarbyl compound such as an alcohol or alkylphenol with two or more units of an alkylene oxide or a mixture of alkylene oxides to form a polyalkoxylated intermediate which can be directly aminated to form a polyetheramine or can be cyanoethylated with acrylonitrile followed by hydrogenation to form a polyetheramine as described in U.S. Pat. No. 5,094,667. The lubricity agent can include alkoxylated and/or polyalkoxylated fatty amines such as diethoxylated tallow amine, fatty carboxy late esters of polyols such as mixtures of glycerol monooleate and glycerol dioleate, and mixtures thereof. Alternatively the antioxidant composition of the present invention can further comprise one or more of the above described fuel additives for example for use in a dosing system or as a concentrate for a bulk treatment or an aftermarket treatment of a normally liquid fuel. In an embodiment of the invention the fuel additive or additives can be present in the fuel composition at 0.1 to 40,000 ppm by weight and in other instances can be present at 1 to 20,000 and 50 to 10,000 and 100 to 1,000 ppm by weight. Antioxidant compositions and fuel compositions of the present invention containing two or more components can generally be prepared by admixing the components. Their preparation can include the use of hydrocarbon solvents, mineral oils and synthetic base oils to facilitate the admixing, and, mixing via a mechanical means at room or elevated temperatures can also be employed.

In a method of the present invention the performance of a lubricating oil of an internal combustion engine is improved by operating the engine wherein an antioxidant composition as described throughout this application is introduced into a combustion chamber of the engine during the operation of the engine. In the method of the invention the improvement in performance of the lubricating oil of the engine can include increased antioxidancy, reduced soot and sludge formation, reduced deposits, viscosity control, reduced wear, increased fuel economy, reduced exhaust emissions to include particulate emissions, and increased lubricant life to meet for example extended drain interval requirements. In the method of the present invention the lubricating oil can comprise an oil of lubricating viscosity, which can be a natural oil, a synthetic oil, or mixtures thereof. Natural oils include various refined mineral oils, animal oils, and vegetable oils. Synthetic oils include hydrogenated poly(alpha-olefins), poly(alkylene glycols), and esters of carboxylic acids. In an embodiment of the invention the lubricating oil can be an American Petroleum Institute Group I-V base oil or a mixture thereof. The lubricating oil of the present invention can further comprise one or more lubricating oil additives to include nitrogen-containing dispersants such as polyisobutenylsuccinimides, metal-containing detergents such as alkali and alkaline earth metal neutral and overbased salts of alkylaryl sulfonates, antioxidants such as sulfurized olefins that can be sulfides or polysulfides or mixtures thereof, antiwear agents such as zinc dialkyl dithiophosphates and organic molybdenum compositions, corrosion inhibitors such as tolyltriazole, viscosity modifiers to include viscosity index improvers and pour point depressants such as various polyolefins and polymethacrylates, friction modifiers such as glycerol mono- and dioleate, and antifoanm agents such as silicones. Lubricating oil additives can be present in a lubricating oil and at a level to provide the required performance for an internal combustion engine. The level of the lubricating oil additive in the lubricating oil can range from about 0.1 ppm by weight to about 20% by weight.

Both recent and future lubricating oil performance requirements and exhaust emission requirements for internal combustion engines are placing additional performance demands on the lubricating oil. The method of the present invention provides a way to improve performance of the lubricating oil by meeting these additional performance demands. These lubricating oil performance requirements and exhaust emission requirements for internal combustion engines include a) extended intervals between lubricating oil changes or drains, b) internal combustion engines containing an exhaust gas recirculation system, c) internal combustion engines having an exhaust treatment device and run on a low sulfur content fuel, d) internal combustion engines having an exhaust treatment device and a lubricating oil that has a reduced level of sulfur, phosphorus and/or sulfated ash where sulfated ash is a measure of the metal content in the oil, and e) various combinations thereof. Exhaust treatment devices can include three-way catalytic converters, NOₓ traps, oxidation catalysts, reduction catalysts and diesel particulate filters. In an embodiment of the method of the present invention the internal combustion engine is a compression-ignited engine having an exhaust gas recirculation system. In an additional embodiment of the method of the invention the internal combustion engine is a spark-ignited direct injection engine having an exhaust gas recirculation system. In another embodiment of the method of the invention the engine is a spark-ignited or compression-ignited engine having an exhaust treatment device, and the lubricating oil has at least one of the properties selected from the group consisting of a phosphorus content below 0.1% by weight, a sulfur content below 0.5% by weight, and a sulfated ash content below 1.5% by weight. In other instances the phosphorus content of the lubricating oil can be below 0.08 or 0.05% by weight, the sulfur content of the lubricating oil can be below 0.3 or 0.2% by weight, and the sulfated ash content of the lubricating oil can be below 1.2 or 1% by weight. In still other instances the phosphorus content of the lubricating oil can be 0.02 to 0.06% by weight, the sulfur content of the lubricating oil can be 0.1 to 0.4% by weight, and the sulfated ash content of the lubricating oil can be 0.1 to 0.9% by weight. In a further embodiment of the method of the present invention the engine is a spark-ignited or compression-ignited engine having an exhaust treatment device, and a fuel of a fuel composition used to fuel the engine has a sulfur content below 80 ppm by weight. In other instances the sulfur content of the fuel can be below 50, 15 or 10 ppm by weight. In still a further embodiment of the method of the invention an engine is installed in a motor vehicle and has a recommended drain interval for a lubricating oil of the engine of greater than 6,000 miles and in other instances of greater than 8,000 or 10,000 miles. In another embodiment of the method of the present invention a stationary engine has a recommended drain interval for a lubricating oil of the engine of greater than 150 operational hours and in other instances of greater than 200 or 250 operational hours.

The following examples demonstrate the method of the present invention where the introduction of the antioxidant composition into a combustion chamber of an internal combustion engine results in improvement in the performance of a lubricating oil of the engine. The examples are provided for illustrative purposes only and are not intended to limit the scope of the invention.

Oil Viscosity Growth Data

A baseline fuel (no additive) and the same fuel additized with antioxidants of Example A and/or Example B were evaluated in a Daimler-Chrysler 2.7 liter engine test. Example A was the reaction product of 2,6-di-t-butylphenol and butyl acrylate in the presence of a catalytic amount of potassium hydroxide to form an ester containing hindered phenol. Example B was the reaction product of diphenylamine and nonenes in the presence of a Lewis acid catalyst to form an alkylated diarylamine. Unless otherwise noted, the test engine was lubricated with a lubricating oil meeting ILSAC GF-2 specifications. Conditions of the test were designed to evaluate the performance of the lubricating oils performance in regards to oil viscosity growth due to build-up of nitration and oxidation by-products in the lubricating oil. The oil viscosity growth was measured via the ability to pump the oil at cold temperatures (−25° C.), and the kinematic viscosity at 40° C. As the data indicates, addition of antioxidants to the fuel minimizes the viscosity growth of the lubricating oil. Additionally, the build tip of nitrated and oxidized by-products in the lubricating oil was measured using Infrared spectroscopy to measure for functionalities associated with oxidation and nitration (C═O and RONO2). As the data in Table 1 indicates, the amount of these functionalities found in the end of test drain oil are less for the oils obtained from engines run using a fuel additized with the aforementioned antioxidants of the present invention. The fuel also contained a gasoline detergent additive.

TABLE 1

| | | Antioxidant added to Fuel | | | | | | |
|---|---|---|---|---|---|---|---|---|
| Test | Lubricant | Example | Example | Test | MRV | Kin Vis. | | |
| Run | Oil | A (ppm) | B (ppm) | Hours | @ −25° C. | @ 40° C. | (RONO₂)² | (C═O)³ |
| 1 | ILSAC-GF2 | 0 | 0 | 100 | 25500 | 114.9 | 612 | 1528 |
| 2 | ILSAC- | 0 | 0 | 100 | | | 43 | 936 |
| | GF2 + AO¹ | | | | | | | |
| 3 | ILSAC-GF2 | 270 | 330 | 100 | 11600 | 88.4 | 9 | 645 |
| | | | | 116 | | 89.3 | 0 | 664 |
| 4 | ILSAC-GF2 | 68 | 86 | 100 | | | 245 | 856 |
| | | | | 120 | 12500 | 95.5 | 284 | 989 |
| 5 | ILSAC-GF2 | 0 | 154 | 120 | 16000 | 104.1 | 322 | 1172 |

¹The antioxidancy of the lubricating oil was boosted with 1.1% wt of an antioxidant (AO) package consisting of Antioxidants of Example A, Example B, and an alkenyl ester sulfide.
²Nitrate ester peak height @1629 cm − 1 on EOT drain oil.
³The difference in carbonyl areas at 1705 cm − 1 of EOT drain oil and the new oil (EOT carbonyl area @ 1705 cm − 1) − (fresh oil carbonyl area @ 1705 cm − 1)

Emissions Data

A baseline fuel (no additive) and the same fuel additized with antioxidant of Example B, described above in the examples for the Oil Viscosity Growth Data, were evaluated in the Caterpillar 1P. This engine test is part, of the API CH-4 test specifications. Particulate emissions were measured under various speeds and load conditions. The weight of particulate matter at these speeds and load conditions is reported in Table 2. As indicated by the data in Table 2, an average of 17.4% reduction in particulate matter was observed while up to 30.8% reduction in particulate matter was observed under low speed and low load conditions when the fuel contained the antioxidant. This reduction in particulate formation results in a reduction of the soot load on both the engine oil and exhaust treatment devices such as diesel particulate traps. Thus, the use of an antioxidant in the fuel provides benefits to both the engine oil and exhaust treatment devices.

TABLE 2
Particulate Emissions Of Caterpillar 1P Engine for Various Speed
and Load Conditions Using Non-Additized and Additized Fuel.

| | | | | | | |
|---|---|---|---|---|---|---|
| Speed | Torque | Duration | | | | % red vs. |
| (rpm) | (Nm) | (Min.) | New | Sooted | Net | Baseline |

Baseline Fuel

| | | | | | |
|---|---|---|---|---|---|
| 1000 | 80 | 30 | 0.4540 | 0.4618 | 0.0078 |
| 1000 | 180 | 30 | | | |
| 1400 | 180 | 30 | | | |
| 1800 | 180 | 30 | 0.4590 | 0.4668 | 0.0078 |
| 1800 | 285 | 30 | 0.4478 | 0.4552 | 0.0074 |

| | |
|---|---|
| Average | 0.00766 |

Baseline Fuel + Antioxidant Example B¹

| | | | | | | |
|---|---|---|---|---|---|---|
| 1000 | 80 | 30 | 0.4547 | 0.4601 | 0.0054 | 30.8% |
| 1000 | 180 | 30 | | | | |
| 1400 | 180 | 30 | | | | |
| 1800 | 180 | 30 | 0.4336 | 0.4411 | 0.0075 | 3.8% |
| 1800 | 285 | 30 | 0.4412 | 0.4473 | 0.0061 | 17.6% |

| | | |
|---|---|---|
| Average | 0.00633 | 17.4% |

¹2% wt treat of antioxidant to Baseline Fuel

Each of the documents referred to in this Detailed Description of the Invention section is incorporated herein by reference. All numerical quantities in this application used to describe or claim the present invention are understood to be modified by the word “about” except for the examples or where explicitly indicated otherwise. All chemical treatments or contents throughout this application regarding the present invention are understood to be as actives unless indicated otherwise even though solvents or diluents may be present.

What is claimed is:

1. A method of operating an internal combustion engine, comprising:
supplying to said engine a fuel containing an antioxidant selected from the group consisting of:
(A) a sterically hindered phenol;
(B) an alkylene or alkylidene coupled sterically hindered phenol oligomer;
(C) a secondary aromatic amine;
(D) a reaction product of a hydrocarbyl-substituted hydroxy-containing aromatic compound, an aldehyde, and a carboxyl-substituted phenol; and
(E) a mixture thereof
wherein the antioxidant composition is essentially free of sulfur and phosphorus.

2. The method of claim 1 wherein the antioxidant composition is introduced into the combustion chamber by injection from a dosing system or as a component of a fuel composition.

3. The method of claim 2 wherein the antioxidant composition is present in the fuel composition at 0.1 to 40,000 ppm by weight.

4. The method of claim 1 wherein the antioxidant composition (A) is a phenol having two or more alkyl substituents that contain 1 to 24 carbon atoms and that occupy the 2-position and 6-position of the phenolic ring.

5. The method of claim 1 wherein the antioxidant composition (B) is a methylene coupled phenol oligomer containing two or more phenolic rings wherein each phenolic ring is occupied at the 2-, 4- and 6-positions by an alkyl or arylalkyl group.

6. The method of claim 1 wherein the antioxidant composition (C) is a diarylamine containing one or more alkyl substituents wherein each substituent contains tip to 16 carbon atoms.

7. The method of claim 1 wherein the antioxidant composition (D) is the reaction product of an alkylphenol, formaldehyde, and salicylic acid.

8. The method of claim 1 wherein the antioxidant further comprises one or more fuel additives.

9. A method of improving the performance of a lubricating oil of an internal combustion engine by operating the engine according to the method of claim 1.

10. The method of claim 9 wherein the engine is a compression-ignited engine or spark-ignited direct injection engine having an exhaust gas recirculation system.

11. The method of claim 9 wherein the engine is a compression-ignited or spark-ignited engine having an exhaust treatment device, and the lubricating oil has at least one of the properties selected from the group consisting of a phosphorus content below 0.1% by weight, a sulfur content below 0.5% by weight, and a sulfated ash content below 1.5% by weight.

12. The method of claim 9 wherein the engine is installed on a motor vehicle and has a recommended drain interval for the lubricating oil of the engine of greater than 6,000 miles.

13. The method of claim 9 wherein the engine is a stationary engine having a recommended drain interval for the lubricating oil of the engine of greater than 150 operational hours.

14. The method of claim 9 wherein the engine is a compression-ignited or spark-ignited engine having an exhaust treatment device, and a fuel of a fuel composition used to filet the engine has a sulfur content below 80 ppm by weight.
